(19) United States
(12) Patent Application Publication
(10) Pub. No.: US 2007/0029698 A1
(43) Pub. Date: Feb. 8, 2007

(54) Layered manufactured articles having small-diameter fluid conduction vents and method of making same

(76) Inventors: Michael L. Rynerson, Pittsburgh, PA (US); James Hetzner, Saginaw, MI (US)

Correspondence Address: IP & INTERNET LAW NORTH, LLC, P.O. BOX 38, ZELIENOPLE, PA, 16063, US

(21) Appl. No.: 10/571,176

(22) PCT Filed: Sep. 9, 2004
(86) PCT No.: PCT/US04/29229

§ 371 Date: Jul. 5, 2006

Related U.S. Application Data
(60) Provisional application No. 60/502,068, filed on Sep. 11, 2003.

(51) Int. Cl. B29C 33/40

(52) U.S. Cl. 264/219; 264/113

(57) ABSTRACT

The invention utilizes a layered manufacturing process to produce an article (2) having at least one small-diameter fluid conduction vent (6) produced during the layered manufacturing process. The invention also includes articles (2) containing at least one small-diameter fluid conduction vent (6) wherein the article (2) and the small-diameter vent or vents (6) are simultaneously produced by a layered manufacturing process.

### TECHNICAL FIELD

The present invention relates to layered manufactured articles which contain at least one small-diameter fluid conduction vent. More specifically, the present invention relates to such articles wherein at least one such vent is produced during the layered manufacturing process. The present invention also relates to methods for making such articles.

### BACKGROUND ART

Many articles of manufacture contain small-diameter fluid conduction vents which permit fluid to flow into and/or out of the article or a portion of the article. For example, molds for making articles from expanded polymer beads like expanded polystyrene (“EPS”) contain a plurality of small-diameter fluid conduction vents for conducting steam into the mold for causing the polymer beads to further expand and bond together. Injection molding molds contain small-diameter fluid conduction vents that allow trapped air to escape from the mold during the injection process. Vacuum forming tools, such as those used for thermoforming plastic sheets, contain small-diameter fluid conduction vents for drawing a vacuum between the tool and the plastic sheet that is to be formed against the tool surface. Fluid regulating devices, such as those used in shock absorbers, also contain at least one small-diameter fluid conduction vent. Heat exchange devices that use either open-loop and closed loop heat exchangers also may contain small-diameter fluid conduction vents.

At present, the creation of a small-diameter fluid conduction vent or vents requires some type of perforation step to be performed on the article, e.g., punching or drilling by some mechanical, electrical, optical or chemical means. In the case of EPS bead molds, vent making requires shouldered holes of between about 0.16 cm and about 0.64 cm to be drilled, cylindrical hardware having slotted end surfaces to be press fitted into the holes, and the mold surface to be machined to assure that the hardware is flush with the mold surface. Alternatively, such vents may be made by laser-drilling followed by manual cleanup of the mold surface to remove flash and other irregularities caused by the laser-drilling operation. Such vents may also be created by electrodischarge machining or by chemical etching or drilling.

Such vent-making processes are costly and time consuming. Moreover, they restrict the placement of vents to areas that are accessible to the tool that will be used for making the vent. If a vent is required in an otherwise inaccessible area, it is necessary to section the article so that the desired area can be accessed, make the vent or vents in the removed section, and then reintegrate the removed area back into the article.

Another drawback of the prior art is that the orientation of the small-diameter fluid conduction vents with respect to the article surface is restricted by the perforation technique employed and the accessibility of the portion of the surface at which an individual small-diameter fluid conduction vent is to be placed. Where the surface shape curves or is complex or access is limited, the small-diameter fluid conduction vent is likely to have a less-than-optimal orientation. Where techniques such as laser or chemical drilling are used, the orientation of the small-diameter fluid conduction vent is usually confined to being nearly perpendicular to the article surface.

What is needed is a method of producing articles that contain at least one small-diameter fluid conduction vent that avoids the costs and the difficulties associated with the use of a perforation technique to produce the vent or vents.

### DISCLOSURE OF INVENTION

One aspect of the present invention is to provide a method of producing articles that contain at least one small-diameter fluid conduction vent which avoids one or more of the drawbacks inherent in the prior art. To this end, the present invention utilizes a layered manufacturing process to produce an article having at least one small-diameter fluid conduction vent wherein the vent or vents are produced during the layered manufacturing process.

The term “layered manufacturing process” as used herein and in the appended claims refers to any process which results in a useful, three-dimensional article that includes a step of sequentially forming the shape of the article one layer at a time. Layered manufacturing processes are also known in the art as “rapid prototyping processes” when the layer-by-layer building process is used to produce a small number of a particular article. The layered manufacturing process may include one or more post-shape forming operations that enhance the physical and/or mechanical properties of the article. Preferred layered manufacturing processes include the three-dimensional printing (“3DP”) process and the Selective Laser Sintering (“SLS”) process. An example of the 3DP process may be found in U.S. Pat. No. 6,036,777 to Sachs, issued Mar. 14, 2000. An example of the SLS process may be found in U.S. Pat. No. 5,076,869 to Bourell et al., issued Dec. 31, 1991. Layered manufacturing processes in accordance with the present invention can be used to produce articles comprised of metal, polymeric, ceramic, or composite materials.

The term “small-diameter” as used herein and the appended claims refers to diameters of about 0.25 cm or less. Preferably, with regard to the present invention, the small-diameter fluid conduction vents have diameters in the size range of from about 0.02 cm to about 0.25 cm.

In contradistinction to the prior art, the present invention gives the article designer the freedom to locate the small-diameter fluid conduction vent or vents wherever they are most needed without resort to sectioning and reassembling the article. The present invention also permits the article designer to optimize both the orientation of the vent or vents and the placement density of multiple vents. For example, the present invention allows the designer to orient the vents of an EPS bead mold parallel to the mold's opening direction to facilitate the easy removal of the formed EPS part and reduce the likelihood of vent blockage by EPS material that might extrude into a vent. The present invention also permits the designer to use a high placement density of vents in areas needing a large amount of ventilation while using a lower placement density of vents in areas needing less ventilation. Moreover, the flexibility provided by the present invention permits the designer to use a computer-run algorithm to optimize vent design, placement, and array density. The computer program containing the algorithm may even create an electronic file incorporating the vents into the article and cause the article to be printed, all with little or no human intervention after the design criteria have been selected.

Another aspect of the present invention is to provide articles containing at least one small-diameter fluid conduction vent wherein the article and the small-diameter vent or vents are simultaneously produced by a layered manufacturing process.

Articles produced by the present invention are particularly well-suited for producing EPS molded foamed articles for use as patterns in lost-foam molding process, drinking cups, Christmas decorations, packing material, floatation devices, and insulation material.

### BRIEF DESCRIPTION OF DRAWING

The criticality of the features and merits of the present invention will be better understood by reference to the attached drawings. It is to be understood, however, that the drawings are designed for the purpose of illustration only and not as a definition of the limits of the present invention.

FIG. 1 is a perspective view of one half of an EPS bead mold containing vents that was produced according to the present invention.

### MODES FOR CARRYING OUT THE INVENTION

In this section, some presently preferred embodiments of the present invention are described in detail sufficient for one skilled in the art to practice the present invention. It is to be understood, however, that the fact that a limited number of presently preferred embodiments are described herein does not in any way limit the scope of the invention as set forth in the appended claims.

For clarity of illustration and conciseness, the description of presently preferred embodiments is limited to the description of making EPS bead molds wherein the layered manufacturing process employed is the 3DP process. Persons skilled in the art will recognize that the present invention includes the making of any type of article having one or more small-diameter fluid conduction vents which is within the size and material capability of any layered manufacturing process that is adaptable to the inclusion of one or more small-diameter fluid conduction vents in the article as it is being built in a layer-wise fashion.

In a conventional EPS bead molding operation, partially-expanded EPS beads are charged into a closed two-piece EPS bead mold. Steam is then introduced into a chamber surrounding the EPS bead mold. The steam is conducted through a plurality of small-diameter fluid conduction vents in the EPS bead mold and causes the blowing agent, such as pentane, within the partially-expanded EPS beads to further expand the beads, which then become fused together in the shape defined by the EPS bead mold. After the steaming step is completed, the molded article is cooled by applying a vacuum to the chamber surrounding the EPS bead mold and/or by spraying water on the outer surfaces of the EPS bead mold. The EPS bead mold is then opened and the molded part is removed. A conventional EPS bead molding operation is described in U.S. Pat. No. 5,454,703 to Bishop, issued Oct. 3, 1995.

The diameter of the vents that conduct the steam into the EPS bead mold must be smaller than the partially-expanded EPS bead size to prevent the beads from either clogging the vents or exiting the mold cavity through the vents. Typically, the partially-expanded EPS beads are on the order of about 0.05 cm in diameter. Partly because of this small size, and partly because of the need to contact with steam all of the partially-expanded EPS beads that are charged into the cavity of the EPS bead mold, it is desirable to have small-diameter fluid conduction vents located over as much of the EPS bead mold surface as possible. However, the problems of perforation tool accessibility to complex or recessed areas of the EPS bead mold's molding surface makes it difficult to optimize vent placement by conventional EPS bead mold making techniques.

In accordance with an aspect of the present invention, a plurality of small-diameter fluid conduction vents may be incorporated into each part of the EPS bead mold as the EPS bead mold part is manufactured by a layered manufacturing process, e.g., the 3DP process.

The 3DP process is conceptually similar to ink-jet printing. However, instead of ink, the 3DP process deposits a binder onto the top layer of a bed of powder. This binder is printed onto the powder layer according to a two-dimensional slice of a three-dimensional electronic representation of the article that is to be manufactured. One layer after another is printed until the entire article has been formed. The powder may comprise a metal, ceramic, polymer, or composite material. The binder may comprise at least one of a polymer and a carbohydrate. Examples of suitable binders are given in U.S. Pat. No. 5,076,869 to Bourell et al., issued Dec. 31, 1991, and in U.S. Pat. No. 6,585,930 to Liu et al, issued Jul. 1, 2003.

The printed article typically consists of from about 30 to over 60 volume percent powder, depending on powder packing density, and about 10 volume percent binder, with the remainder being void space. The printed article at this stage is somewhat fragile. Post-printing processing may be conducted to enhance the physical and/or mechanical properties of the printed article. Typically, such post-printing processing includes thermally processing the printed article to replace the binder with an infiltrant material that subsequently hardens or solidifies, thereby producing a highly dense article having the desired physical and mechanical properties. Where an infiltration step is used, it is necessary to prevent the infiltration from closing off the small-diameter fluid conduction vents. The techniques described in U.S. Pat. No. 5,775,402 to Sachs et al., issued Jul. 7, 1998, with regard to avoiding infiltrant from blocking coolant channels formed within layered manufactured articles may be employed to prevent infiltrant from blocking vents in articles produced according to the present invention.

The three-dimensional electronic representation of the article that is used in the layered manufacturing process is typically created using Computer-Aided Design (“CAD”) software. The CAD file of the three-dimensional electronic representation is typically converted into another file format known in the industry as stereolithographic or standard triangle language (“STL”) file format or STL format. The STL format file is then processed by a suitable slicing program to produce an electronic file that converts the three-dimensional electronic representation of the article into an STL format file comprising the article represented as two-dimensional slices. The thickness of the slices is typically in the range of about 0.008 cm to about 0.03 cm, but may be substantially different from this range depending on the design criterion for the article that is being made and the particular layered manufacturing process being employed. Suitable programs for making these various electronic files are well-known to persons skilled in the art.

The making of one piece of a two-piece EPS bead mold will now be described as an illustration of practicing an aspect of the present invention. Each piece of the EPS bead mold is considered herein to be a separate article, and the second piece may be made either separately from or simultaneously with the first piece.

First, a three-dimensional electronic representation of the mold piece is created as a CAD file and then converted into an STL format file. Next, a CAD file is created of a three-dimensional electronic representation of the array of small-diameter fluid conduction vents that the article is to have. The CAD file of the array of vents is then converted into an STL format file.

Persons skilled in the art will recognize that in creating each of the article and vent CAD files, the dimensions of the article and the vents must be adjusted to take into consideration any dimensional changes, such as shrinkage, that may take place during the manufacturing process. For example, in order to compensate for shrinkage during the manufacture by a 3DP process of a particular article, a vent that is to have a final diameter of 0.046 cm may be designed to be printed with a 0.071 cm diameter.

The two STL format files are compared to make sure that the individual vents will be in desired positions in the article. Any desired corrections or modifications to the STL files may be made thereto. The two STL format files are then combined using a suitable software program that performs a Boolean operation such as binary subtraction operation to subtract the three-dimensional representation of the vents from the three-dimensional representation of the article. An example of such a program is the Magics RP software, available from Materialise NV, Leuven, Belgium. Desired corrections or modifications may also be made to the resulting electronic representation, e.g., removing vents from areas where they are not wanted.

The file combination step results in a three-dimensional electronic file of the article which contains the desired array of small-diameter fluid conduction vents. Such an electronic file is referred to herein as a “3-D vented-article file.” A conventional slicing program then may be used to convert the 3-D vented article file into an electronic file comprising the article represented as two-dimensional slices. Such an electronic file is referred to herein as a “vented article 2-D slice file.” The vented article 2-D slice file may be checked for errors and any desired corrections or modifications may be made thereto. The vented article 2-D slice file is then employed by a 3DP process apparatus to create a printed version of the article, which may subsequently be processed further to improve its physical and/or mechanical properties. An example of such a 3DP process apparatus is a ProMeta® Model RTS 300 unit that is available from Extrude Hone Corporation, Irwin, Pa. 15642.

It is to be understood that the method disclosed in the preceding paragraphs for producing an electronic representation of the article containing the desired small-diameter fluid conduction vent or vents that is usable by a layered manufacturing process apparatus to make the article layer-by-layer is only one of many ways to make such an electronic representation. The exact method used is up to the discretion of the designer and will depend on factors such as the complexity and size of the article, the size and number of the small-diameter fluid conduction vents that the article is to have, the computer processing facilities that are available, and the amount of computational time that is available for processing the electronic file or files. For example, where a simple article contains only a single small-diameter fluid conduction vent, it may be expeditious to include the vent into the initial CAD file containing the three-dimensional electronic representation of the article. In other cases, it may be desirable to eliminate just the step of comparing the STL files of the vent array and the article prior to combining the two files. Persons skilled in the art will recognize that some layered manufacturing processes make the slicing step transparent to the user, i.e., the user only inputs into the processing apparatus a CAD or STL file of a three-dimensional representation of the object and the apparatus automatically performs the additional operations necessary to generate the two-dimensional slices needed to construct the article layer-by-layer. Nonetheless, the slicing operation still is performed in such processes. It is to be understood that all possible variations of producing an electronic representation of the article having a small-diameter fluid conduction vent or vents that are utilizable by a layered manufacturing process apparatus are within the contemplation of the present invention.

The present invention permits the designer to use a computer-run algorithm to optimize vent design, placement and array density. The computer program containing the algorithm may be used to also create an electronic file incorporating the vents into the article, e.g., in the manner described above. It may also cause the article to be printed. Thus, this aspect of the present invention permits the designer to go from design criterion to printed article all with little or no human intervention after the design criteria have been selected. The design of such an algorithm and the related software to run it is well within the skill of those skilled in the art through the integration of the principles of fluid dynamics, article design, machine automation, and computer programming.

Another aspect of the present invention is to provide articles containing at least one small-diameter fluid conduction vent wherein the article and the vent or vents are simultaneously produced by a layered manufacturing process. Examples of such articles include, without limitation, EPS bead molds and portions thereof, vented injection molds, vacuum forming tools, heat transfer devices, and fluid regulating devices, such as those used in shock absorbers.

Persons skilled in the art will recognize that articles that are within the contemplation of the present invention are distinguishable from articles having small-diameter fluid conduction vents made by other methods. For example, in some cases, such articles may be distinguished by the placement and orientation of the vent or vents which are not achievable by any other production means. This is so because the prior art placement and orientation of vents is restricted by perforation tool accessibility, whereas the present invention permits vents to be placed anywhere in the article and oriented in any direction. Articles made according to the present invention may also be distinguished by the wall texture of the individual vents as the walls of vents produced by perforation means may exhibit signs of the vent-forming method employed whereas vents made according to the present invention may exhibit a texture characteristic of the layer-by-layer building process that was used to produce the article.

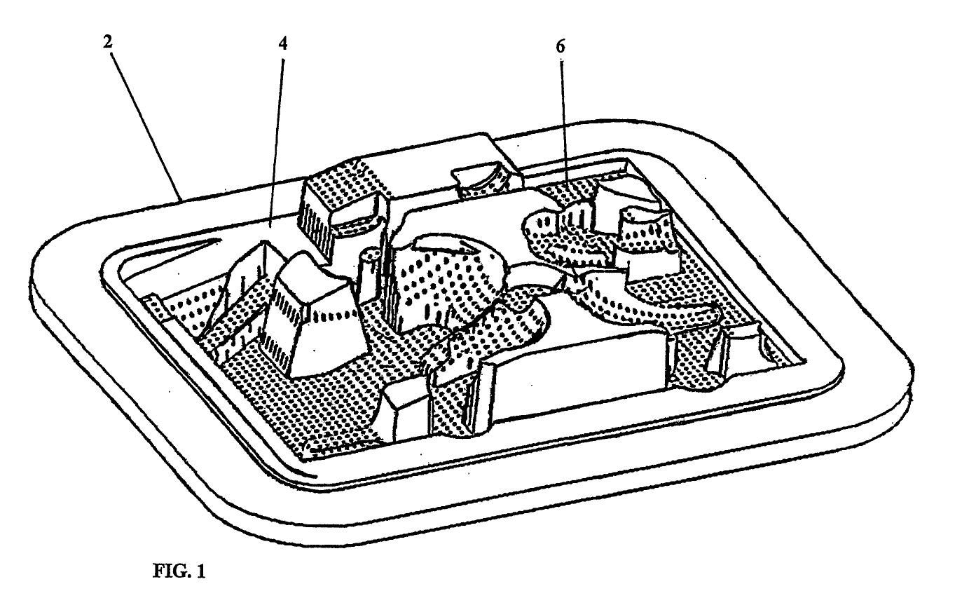

An example of an article containing small-diameter fluid conduction vents wherein the article and the vents were simultaneously produced by a layered manufacturing process is shown in FIG. 1. The article shown is the lower half of an EPS bead mold that is used for making a lost foam pattern for a demonstration single-cylinder engine head. The mold half 2 has a complex mold surface 4 and, at the print stage, is 28.2 cm long by 23.1 cm wide by 5.8 cm thick. The mold half 2 contains several hundred small-diameter fluid conduction vents 6. Each of the vents 6 is cylindrical with a round cross-section and is 0.09 cm wide. The vents 6 are all oriented parallel to the opening direction 8 of the EPS bead mold, i.e. the Z-direction. The complex curvature of the mold surface 4 causes some of the vents 4 to appear elongated at their terminations in the mold surface 4. The printed mold half 2 was made using the 3DP process using grade 420 stainless steel powder that had a particle size of −170 mesh/+325 mesh and a printing binder. The printing binder was ProMetal® SBC-1, a carbohydrate/acrylic binder that is available from Extrude Hone Corporation, Irwin, Pa. 15642.

The printed article was subsequently infiltrated with a 90 percent by weight copper, 10 percent by weight tin bronze alloy to enhance its physical and mechanical properties. During the infiltration step, infiltrant flow into the vents was substantially prevented by controlling the elevation of the printed article above the source from which the infiltrant was wicked into the printed article so as to balance the capillary forces of infiltration with the static head pressure of the infiltrant. This elevation control technique permitted the article to be fully infiltrated without obstructing the vents 6 with infiltrant or causing them to become undersized. Another technique that can be used instead of or in addition to the elevation control technique to prevent the vents from being obstructed or becoming undersized by the infiltrant is to oversize the vents 6 to allow for some skinning of the interior surfaces of the vents 6 by the infiltrant.

Only a relatively small amount of surface finishing work was necessary to produce the desired surface finish to the mold surface 4.

While only a few embodiments of the present invention have been shown and described, it will be obvious to those skilled in the art that many changes and modifications may be made thereunto without departing from the spirit and scope of the invention as described in the following claims. All United States patents referred to herein are incorporated herein by reference as if set forth in full herein.

1-36. (canceled)

37. A method for producing an article that is a component of a multi-piece mold, said mold having a direction of opening in use, said method comprising the steps of:
(a) designing said article to have a plurality of small-diameter fluid conduction vents, wherein said designing includes orienting each of said plurality of small-diameter fluid conduction vents to have a centerline oriented parallel to said direction of opening;
(b) generating an electronic file of the design created in step (a) of said article; and
(c) making said article from said electronic file by a layered manufacturing process.

38. The method of claim 37, further comprising the step of selecting the layered manufactured process to be three-dimensional printing.

39. The method of claim 37, further comprising the step of infiltrating said article with an infiltrant.

40. The method of claim 39, further comprising the step of selecting said infiltrant to be a molten metal.

41. A method for making an article having at least one small-diameter fluid conduction vent, said method comprising the steps of:
(a) designing said article to have at least one small-diameter fluid conduction vent;
(b) generating an electronic file of the design created in step (a) of said article; and
(c) making said article from said electronic file by a three-dimensional printing process utilizing a powder and a binder.

42. The method of claim 41, wherein said powder includes at least one selected from the group consisting of a metal, a ceramic, a polymer, and a composite.

43. The method of claim 41, wherein at least one of said small-diameter fluid conduction vent or vents has a diameter in the range of between about 0.02 cm and about 0.25 cm.

44. The method of claim 41, wherein step (a) further includes the steps of:
(i) providing an algorithm; and
(ii) executing said algorithm on a computer to do at least one of the following:
(1) design at least one of said small-diameter fluid conduction vent or vents;
(2) select a location for at least one of said small-diameter fluid conduction vent or vents within said article;
(3) select an array density for a plurality of said small-diameter fluid conduction vents for at least a portion of a surface of said article; and
(4) incorporate an electronic representation of at least one of said small-diameter fluid conduction vent or vents into an electronic representation of said article.

45. The method of claim 41, further comprising the step of selecting said article to be a component of at least one selected from a group consisting of an injection mold, a vacuum forming tool, a heat transfer device, a fluid regulating device, and an EPS bead mold.

46. The method of claim 41, further comprising the step of infiltrating said article with an infiltrant.

47. The method of claim 46, further comprising the step of selecting said infiltrant to be a molten metal.

48. The method of claim 46, further comprising the steps of:
a) using said infiltrated article after said step of infiltrating to make a pattern; and
b) using said pattern in a lost-foam molding process.

49. The method of claim 46, further comprising the step of using said article after said step of infiltrating in at least one selected from a group consisting of an EPS bead molding process, an injection molding process, a vacuum forming process, a heat transfer device, and a fluid regulating device.

50. The method of claim 41, wherein step (a) includes the step of orienting at least one of said small-diameter fluid conduction vent or vents in a direction that is not substantially normal to a surface at which said small-diameter fluid conduction vent terminates.

51. The method of claim 41, wherein step (c) includes the step of selecting the binder to be used in the three-dimensional printing process to comprise at least one of a polymer and a carbohydrate.

52. A method for making an article having at least one small-diameter fluid conduction vent, said method comprising the steps of:
a) designing said article;
b) creating a first electronic file containing a representation of said article, wherein at least one of said fluid conduction vent or vents is absent from said representation of said article;
b) creating a second electronic file containing a representation of at least one of said absent small-diameter fluid conduction vent or vents;
c) combining said first electronic file with said second electronic file to create a third electronic file containing a representation of said article with at least one of said absent small-diameter fluid conduction vent or vents positioned within said article; and
(d) making said article from said third electronic file by three-dimensional printing from a powder.

53. The method of claim 52, further comprising the step of selecting said article to be a component of at least one selected from a group consisting of an injection mold, a vacuum forming tool, a heat transfer device, a fluid regulating device, and an EPS bead mold.

54. The method of claim 52, further comprising the step of infiltrating said article with an infiltrant.

55. The method of claim 54, further comprising the step of selecting said infiltrant to be a molten metal.

56. The method of claim 54, further comprising the steps of:
a) using said infiltrated article after said step of infiltrating to make a pattern; and
b) using said pattern in a lost-foam molding process.
